(19) United States
(12) Patent Application Publication
(10) Pub. No.: US 2023/0000026 A1
(43) Pub. Date: Jan. 5, 2023

(54) PORTABLE GROUND COVER DEVICES

(71) Applicant: Ryan L. Dickerson, Mooresville, NC (US)

(72) Inventor: Ryan L. Dickerson, Mooresville, NC (US)

(21) Appl. No.: 17/806,577

(22) Filed: Jun. 13, 2022

Related U.S. Application Data
(60) Provisional application No. 63/217,234, filed on Jun. 30, 2021.

(30) Foreign Application Priority Data
May 23, 2022 (CN) 202210560257.7
May 23, 2022 (CN) 202221236942.6

(51) Int. Cl. A01G 9/16; A01G 9/14

(52) U.S. Cl. CPC A01G 9/16; A01G 9/1438

(57) ABSTRACT

Portable ground cover devices, kits, and methods of assembly and use. A ground cover device includes a frame that may be assembled to a size suitable for use to cover a garden. A cover may be attached to the frame such that the cover is within an interior of the frame when assembled. When in an expanded configuration, the device may be placed over the garden to encourage plant growth and protect the garden from adverse weather, wildlife, and other environmental stressors. The device may be transitioned from the expanded configuration to a retracted configuration for storage or transport of the device when not in use.

### CROSS-REFERENCE TO RELATED APPLICATIONS

This application claims the benefit of prior-filed U.S. provisional application No. 63/217,234 filed on Jun. 30, 2021, prior-filed Chinese application No. 202210560257.7 filed on May 23, 2022, and prior-filed Chinese application No. 202221236942.6 filed on May 23, 2022.

### FIELD

The disclosure relates to portable ground cover devices that may be used in an expanded configuration to cover a garden. Devices are configured to be easily transitioned from the expanded configuration to a retracted configuration for storage or transport of the devices when not in use.

### BACKGROUND

Garden covers and greenhouses provide many benefits to gardeners and gardening efforts. Garden covers protect plants from wildlife and adverse weather and are often used to keep plants warmer to promote plant growth and health during colder weather. Many garden covers function as greenhouses and operate by allowing sufficient light to reach the plants and retaining moisture within the interior of the greenhouse.

Many existing garden covers and greenhouses require tools for assembly, installation, and disassembly, or are otherwise inconvenient or difficult to assemble, install, and disassemble, and are often not structurally durable. Many gardeners assemble and install these devices initially and leave them installed and covering the garden throughout the year due to the difficulty involved with disassembly. This results in these devices being constantly exposed to weather and environmental stressors which causes rapid deterioration and failure of these devices. For example, metal frames and joints of such devices, which may be within an interior of the cover of the greenhouse and exposed to the higher humidity therein, are at greater risk for rusting and becoming immobile, unusable, or destroyed. As another example, frames and covers of these devices are constantly exposed to ultraviolet (UV) light which causes UV damage and deterioration of components. As yet another example, these devices may be too lightweight or may catch the wind and be removed from the intended location, resulting in damage to the devices or nearby people, animals, plants, or objects. It is typical that, after a relatively short period of use, these devices must either be intensively repaired or replaced entirely.

In addition, many existing garden covers and greenhouses are not effective for certain gardens or environments, such as gardens placed on or near a portion of uneven ground. After installation in these environments, gaps appear between the cover and the irregular terrain. These gaps may result from the cover being pulled taut between structures of the frame, such that the bottom edge of the cover does not effectively or reliably contact lower portions of the terrain and fails to form a seal around the perimeter of the device. The lack of the seal causes loss of moisture from the interior of the greenhouse which in turn inhibits growth of the plants.

Accordingly, there is a need for high-quality portable garden cover devices that are easier to assemble, install, store, and transport, and which are of a more durable construction designed to withstand continuous and repeated uses. The present disclosure addresses these unmet needs.

### SUMMARY

This disclosure provides improved durable ground cover devices that may be easily assembled for use and disassembled for storage or transport, without necessarily requiring a user to use tools or to follow a large number of complex steps. A ground cover device includes a frame that is configured to expand and contract to transition the frame between a contracted configuration and an expanded configuration, and a cover that is attachable to the frame to contact the ground and create a greenhouse space within the cover.

For use of the device, the cover may be attached to the frame such that the cover is positioned within an interior volume formed by the frame and the frame is positioned outside an exterior surface of the cover, or alternatively, the cover may be attached to the frame such that the cover is positioned outside of the interior volume formed by the frame and the frame is positioned inside an interior surface of the cover. A configuration with an external frame and an internal cover may prevent humidity within the cover from causing rust or deterioration of the frame, and in addition, may enable lower portions of an outer perimeter of the cover to consistently and reliably contact the ground surface thereunder to form and maintain a seal around the greenhouse space, even in the presence of irregular terrain and adverse weather such as rain and wind. A configuration with an internal frame and an external cover may prevent exposure of the frame to adverse weather conditions such as rain, wind, and sunlight, and may provide other benefits as well.

The ground cover devices are easily assembled for use when needed and are easily disassembled for storage or transport when not needed, such as may occur during the Spring season. The devices may be provided as greenhouse devices that allow sunlight in and also retain sufficient moisture to encourage plant growth. The devices are portable and are of an improved quality and durability, and include innovative features that, individually and collectively, provide various benefits as described herein and as may be apparent upon practicing the invention in any of its various forms, whether explicitly or implicitly disclosed herein.

Various objects, features and advantages of the present invention will become apparent from the following detailed description taken in conjunction with the accompanying drawings.

### BRIEF DESCRIPTION OF THE DRAWINGS

Although the characteristic features of the invention will be particularly pointed out in the claims, exemplary implementations of the invention and manners in which they may be made and used may be better understood after a review of the following description, taken in connection with the accompanying drawings, wherein like numeral annotations are provided throughout.

FIG. 1A depicts a perspective view of a first exemplary medium-sized ground cover device, according to the present disclosure, in an expanded configuration.

FIG. 1B depicts a perspective view of a second exemplary medium-sized ground cover device, according to the present disclosure, in an expanded configuration.

FIG. 1C depicts a perspective view of the first medium-sized ground cover device, in an intermediate configuration.

FIG. 1D depicts a perspective view of the second medium-sized ground cover device, in an intermediate configuration.

FIG. 1E depicts a perspective view of the first medium-sized ground cover device, in a contracted configuration.

FIG. 1F depicts a perspective view of the second medium-sized ground cover device, in a contracted configuration.

FIG. 2A depicts a perspective view of several components of a ground cover device, in an unassembled state.

FIG. 2B depicts a perspective view of an assembly of a cover.

FIG. 2C depicts a perspective view of an unfolding of an adjustable ridge member.

FIG. 2D depicts a perspective view of an assembly of a cover with the adjustable ridge member.

FIG. 2E depicts a perspective view of a first or a second scissor cross member comprised of two ground poles and a plurality of scissor hinges in a contracted configuration.

FIG. 2F depicts a perspective view of connection of upper portions of first and second ground poles to a first upper chord that includes a first apex.

FIG. 2G depicts a perspective view of a ground cover device in an intermediate configuration, and connection of an upper portion of a third ground pole to a second upper chord that includes a second apex.

FIG. 2H depicts a perspective view of a ground cover device assembled in an expanded configuration, and several insets showing close-up perspective views of assembly steps involved with assembling a cover and attaching the cover to the frame.

FIG. 2I depicts an inset showing a close-up perspective view of a hinge joint of an adjustable ridge member in a closed and locked configuration.

FIG. 2J depicts an inset showing a close-up perspective view of the hinge joint, with a user depressing a spring member to unlock the hinge joint.

FIG. 2K depicts an inset showing a close-up perspective view of the hinge joint, in an unlocked and opened configuration.

FIG. 2L depicts a perspective view of several steps involved with a transition of the device from the expanded configuration to the contracted configuration.

FIG. 2M depicts an inset showing a close-up perspective view of the hinge joint and an inset showing a close-up perspective view of a sleeve.

FIG. 3A depicts a perspective view of a first exemplary large-sized ground cover device, according to the present disclosure, in an expanded configuration.

FIG. 3B depicts a perspective view of a second exemplary large-sized ground cover device, according to the present disclosure, in an expanded configuration.

FIG. 3C depicts a perspective view of the first large-sized ground cover device, in an intermediate configuration.

FIG. 3D depicts a perspective view of the second large-sized ground cover device, in an intermediate configuration.

FIG. 3E depicts a perspective view of the first large-sized ground cover device, in a contracted configuration.

FIG. 3F depicts a perspective view of the second large-sized ground cover device, in a contracted configuration.

FIG. 4A depicts a perspective view of a first exemplary small-sized ground cover device, according to the present disclosure, in an expanded configuration.

FIG. 4B depicts a perspective view of a second exemplary small-sized ground cover device, according to the present disclosure, in an expanded configuration.

FIG. 4C depicts a perspective view of the first small-sized ground cover device, in an intermediate configuration.

FIG. 4D depicts a perspective view of the second small-sized ground cover device, in an intermediate configuration.

FIG. 4E depicts a perspective view of the first small-sized ground cover device, in a contracted configuration.

FIG. 4F depicts a perspective view of the second small-sized ground cover device, in a contracted configuration.

### DETAILED DESCRIPTION

Reference is made herein to the attached drawings. Like reference numerals may be used in the drawings to indicate like or similar elements of the description. The figures are intended for representative purposes, are not drawn to scale, and should not be considered limiting.

### I. Definitions

Unless otherwise defined herein, terms and phrases used in connection with the present disclosure shall have the meanings that are commonly understood by those of ordinary skill in the art.

Where a reference is made to a singular noun, whether with or without use of an indefinite or definite article (e.g., “a”, “an”, or “the”), this includes a plural of that noun unless something else is specifically stated. Furthermore, the terms first, second, third, and the like in the description and in the claims, are used for distinguishing between elements and not necessarily for describing a sequential or chronological order. It is to be understood that the terms so used are interchangeable under appropriate circumstances and that the implementations of the disclosure described herein are capable of operation in other sequences than described or illustrated herein.

As used herein, the term “about” refers to the usual error range for the respective value readily known to the skilled person in this technical field. Reference to “about” a value or parameter herein includes and describes implementations and embodiments that are directed to that value or parameter per se.

As used herein, the terms “attachable”, “connectable”, and “adjustable”, and other terms that may indicate an ability of an element to have a property or characteristic as part of a state of the element, include states of the element in which it has the property or characteristic (e.g., is attachable and is attached) as well as states of the element in which it does not have the property or characteristic (e.g., is attachable but is not attached), unless something else is specifically stated. If an element is described as having a property or characteristic (e.g., is attached), this includes elements that may conditionally have the property or characteristic (e.g., may be conditionally attached) as well as elements that may unconditionally have the property or characteristic (e.g., may be unconditionally attached), unless something else is specifically stated.

### II. Ground Cover Devices

This disclosure provides improved ground cover devices that are durable and structurally robust, and may be easily assembled for use and disassembled for storage or transport without necessarily requiring tools or complex steps. Ground cover devices may be provided as greenhouse devices for use with gardening and cultivation of plants, and may be configured to maintain a seal between an interior of a cover of the device and an exterior of the cover, such that moisture is effectively maintained within the interior of the cover to encourage plant growth. The greenhouse devices are easily transitioned between an expanded configuration and a contracted configuration for use and storage or transport and provide significant improvements compared to previous ground cover devices in usability, durability, and utility.

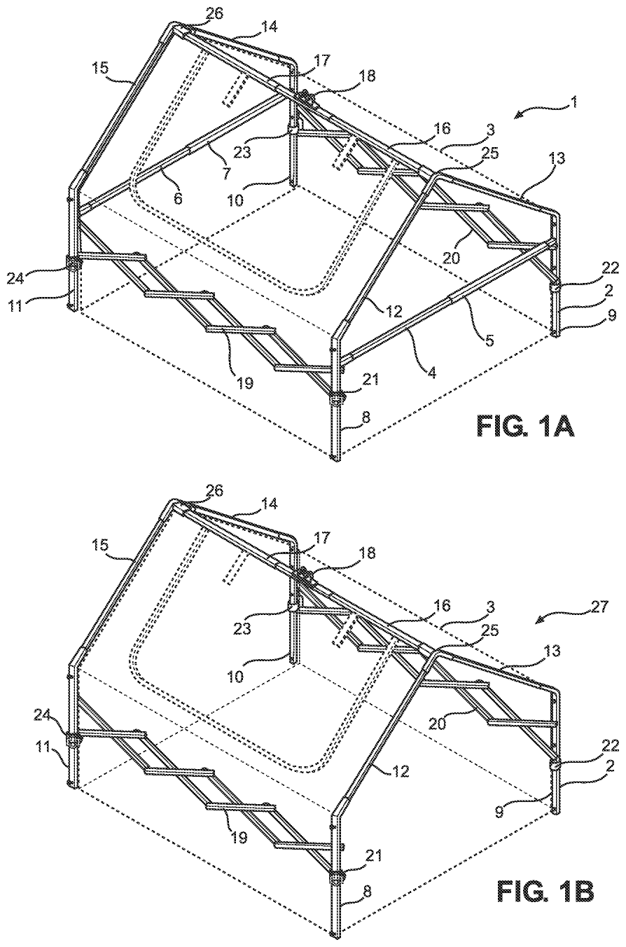

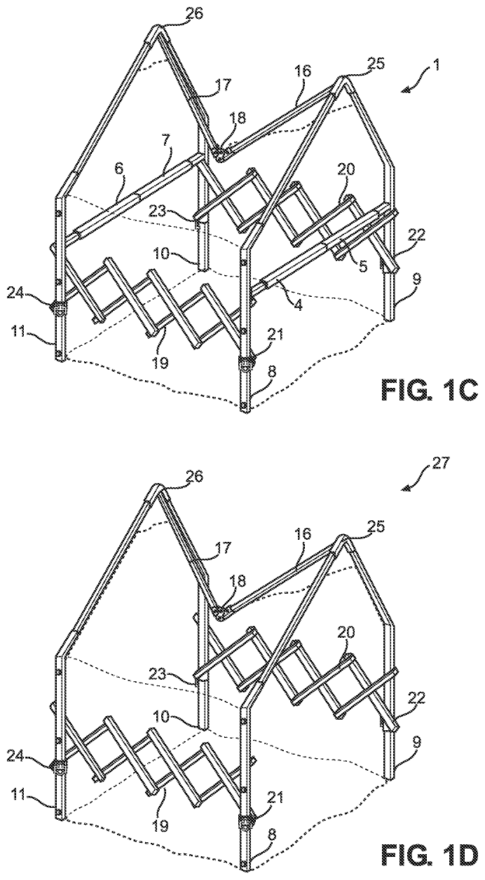

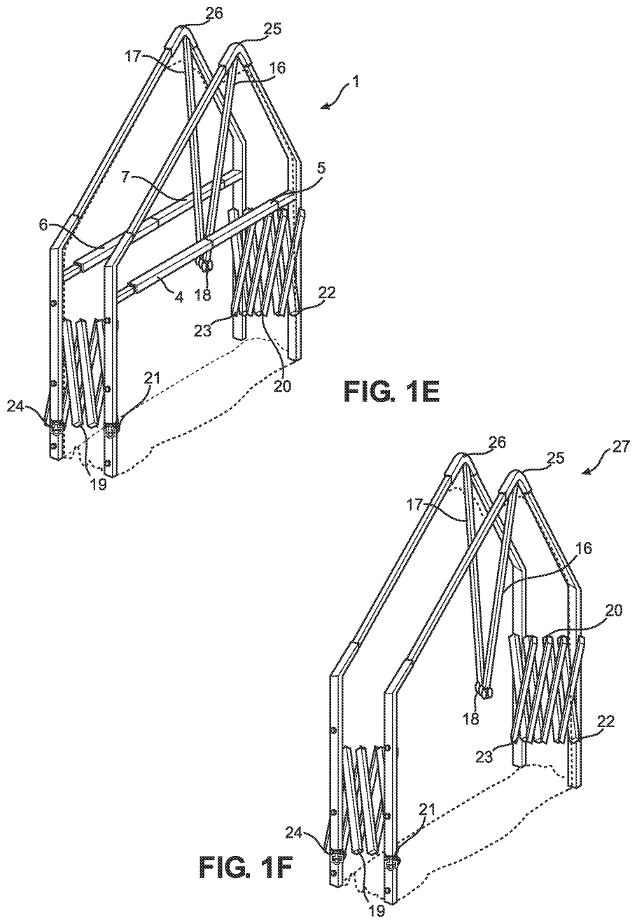

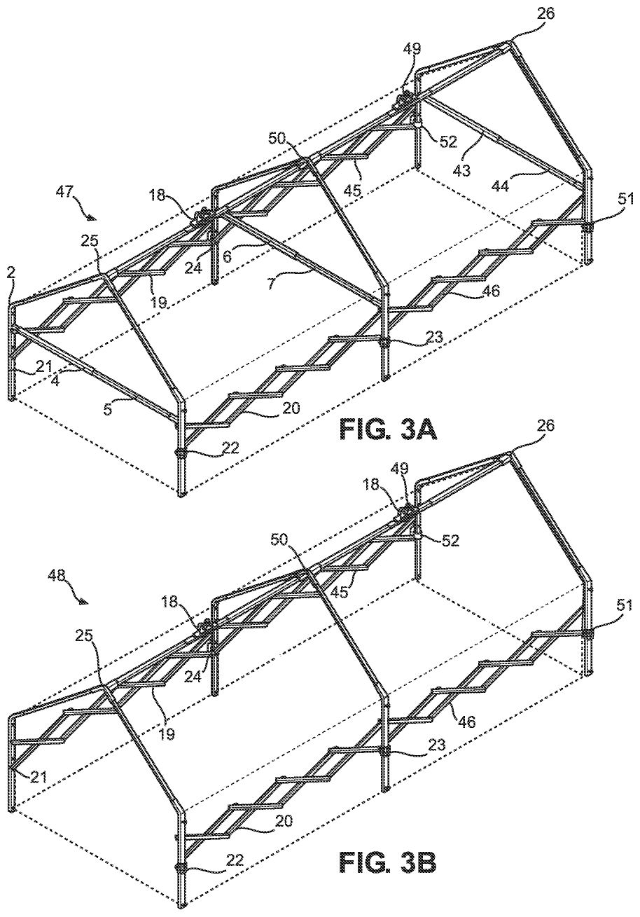

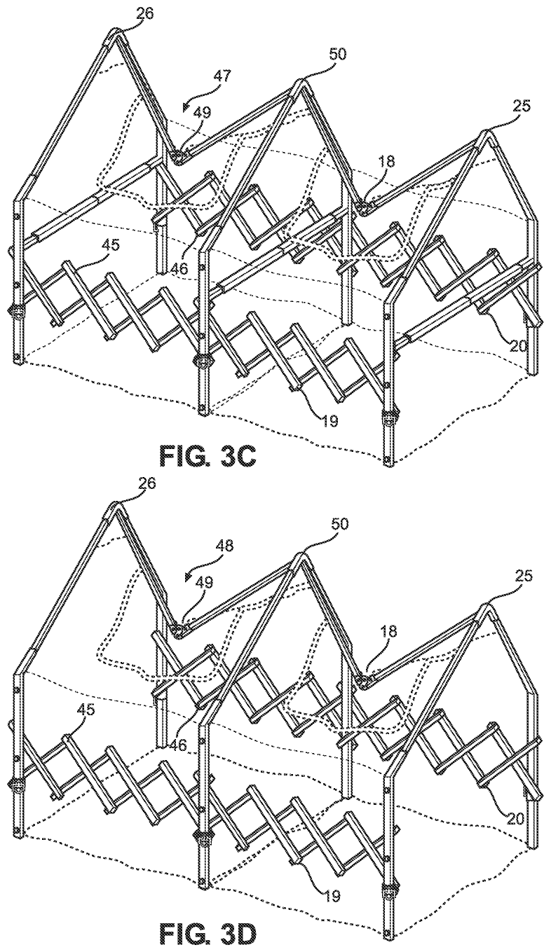

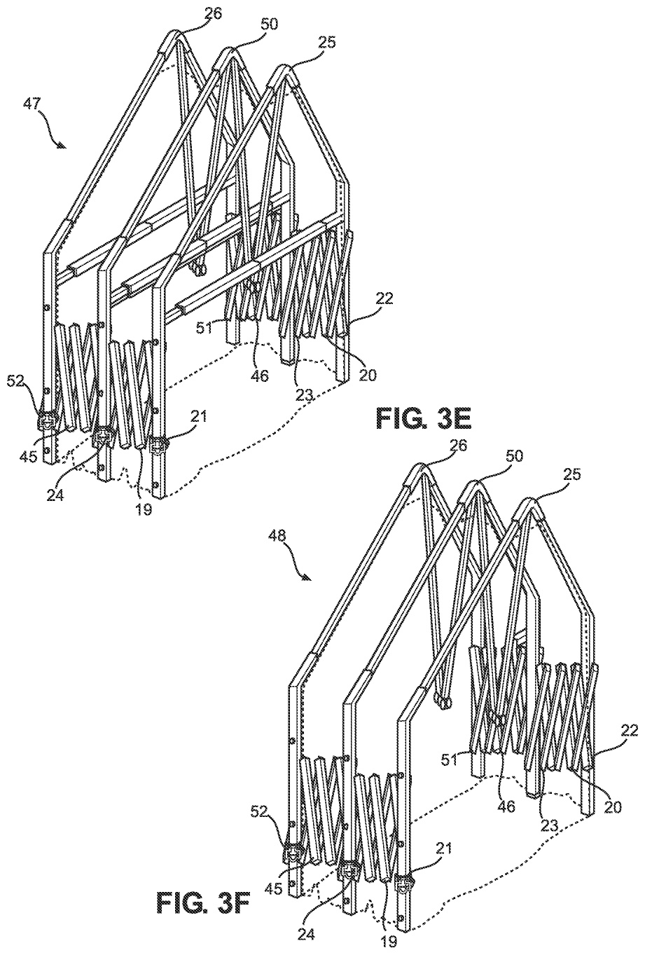

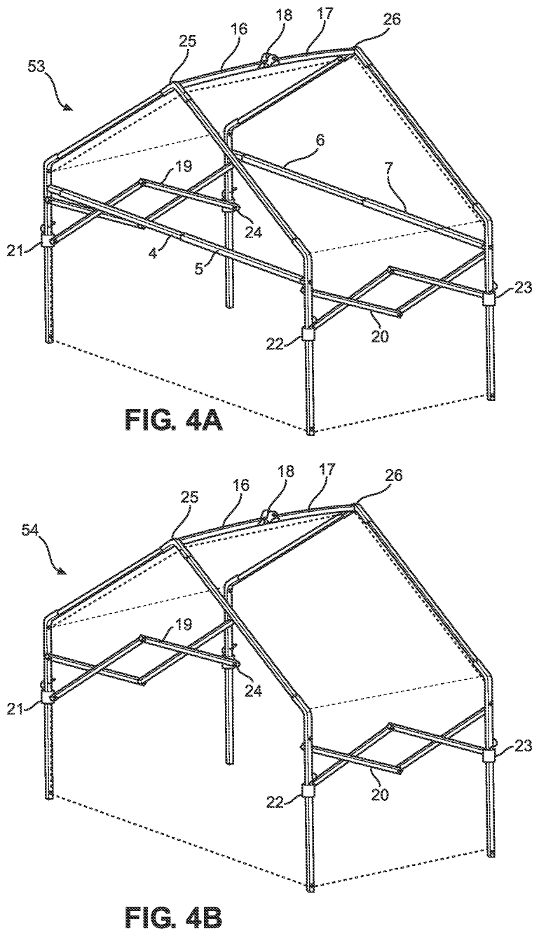

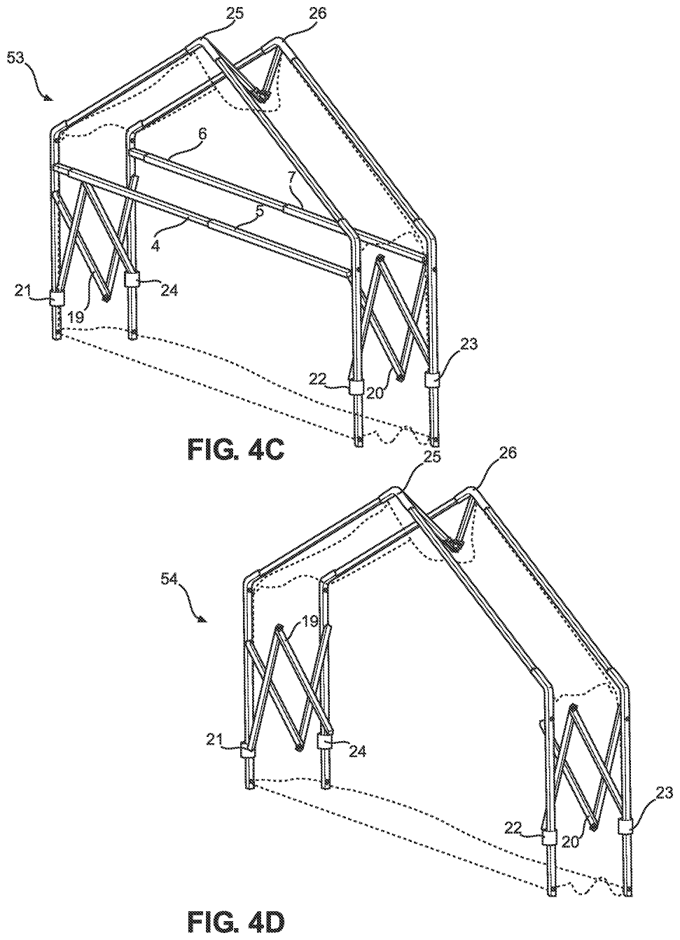

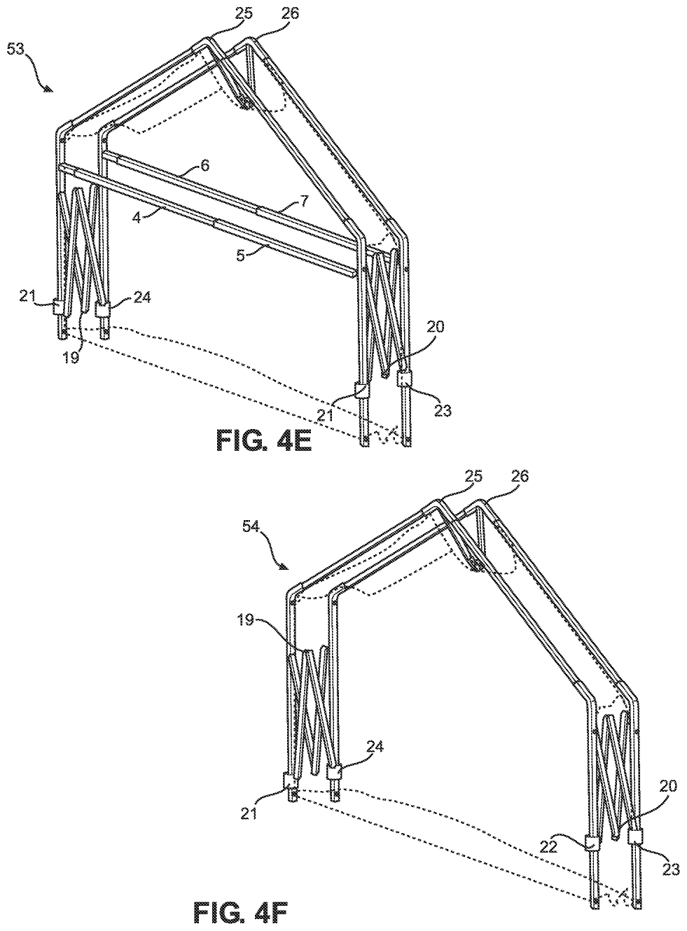

Referring now to FIGS. 1A-1F, 3A-3F, and 4A-4F, there are shown perspective views of a first exemplary medium-sized ground cover device (FIGS. 1A, 1C, 1E), a second exemplary medium-sized ground cover device (FIGS. 1B, 1D, 1F), a first exemplary large-sized ground cover device (FIGS. 3A, 3C, 3E), a second exemplary large-sized ground cover device (FIGS. 3B, 3D, 3F), a first exemplary small-sized ground cover device (FIGS. 4A, 4C, 4E), and a second exemplary small-sized ground cover device (FIGS. 4B, 4D, 4F).

While it is generally intended that any of the exemplary ground cover devices disclosed herein (1, 27, 47, 48, 53, 54) may be any size, in certain embodiments, larger ground cover devices (47, 48) may have improved stability with inclusion of additional components in the design compared to medium-sized ground cover devices (1, 27), and smaller ground cover devices (53, 54) may not have as many components compared to medium-sized ground cover devices (1, 27). In various instances, the decision to include or omit components in a design may be made based on various economic or technical factors such as cost of materials and shipping, design and manufacturing considerations, scalability of a particular design or configuration, market demand, and intended uses, among others. Similarly, particular forms of the ground cover device may be particularly beneficial or advantageous for particular uses or situations; for example, an urban gardener may prefer a small (53, 54) or a medium-sized (1, 27) ground cover device due to limited space available in urban environments for gardening, while a suburban or rural gardener may prefer a medium-sized (1, 27) or a large (47, 48) ground cover device to utilize the generally greater amount of space available for gardening in these types of areas. However, these general considerations do not limit the utility of any embodiment of the ground cover device to a particular scenario or the scope of this disclosure to a particular embodiment or embodiments. As would be understood by the person having ordinary skill in the art, any particular form of the ground cover device may be used in any of these and other uses or situations.

a. Components

A ground cover device (1 and 27 of FIGS. 1A-1F; 47 and 48 of FIGS. 3A-3F; 53 and 54 of FIGS. 4A-4F), which may be a greenhouse device, includes a frame 2 and a cover 3 (cover shown in dotted lines) that may be attached to the frame as part of an assembly of the device and detached from the frame as part of a disassembly of the device. The frame 2 includes a plurality of ground poles 8, 9, 10, and 11 (see also additional ground poles of FIGS. 3A-3F) that are connectable via a plurality of cross members 19, 20 (see also 4 and 5, and 6 and 7 of FIGS. 1A, 1C, 1E, 3A, 3C, 3E, 4A, 4C, and 4E). As cross members are adjusted such that lengths of the adjusted cross members increase, ground poles move further apart toward an expanded configuration of the frame. As cross members are adjusted such that lengths of the adjusted cross members decrease, ground poles move closer together toward a contracted configuration of the frame. While the frame is in an expanded configuration (e.g., FIGS. 1A, 1B, 3A, 3B, 4A, 4B) the ground cover device may be configured for use to cover at least a portion of a ground or a garden, and while the frame is in a contracted configuration (e.g., FIGS. 1E, 1F, 3E, 3F, 4E, 4F) the ground cover device may be configured for storage or transport. In this manner, the device may be easily assembled, expanded for use, contracted for storage or transport, and disassembled for long-term storage, as needed. Connections between components may be made by hand without necessarily needing tools, and components are made of durable materials to provide sufficient support to the frame for long-term use.

In embodiments, the arrangement of ground poles may be rectangular, and the plurality of ground poles includes a first ground pole 8, a second ground pole 9, a third ground pole 10, and a fourth ground pole 11 (see also additional ground poles of FIGS. 3A-3F). The first ground pole 8 is connectable to the fourth ground pole 11 via a first adjustable cross member 19, and the second ground pole 9 is connectable to the third ground pole 10 via a second adjustable cross member 20. In the shown embodiments, the first and second adjustable cross members are scissor cross members 19, 20 (see also additional adjustable cross members as scissor cross members 45, 46 of FIGS. 3A-3F), but other adjustable cross member structures, including but not limited to telescopic adjustable cross members, may be used without departing from the scope of this disclosure.

In various implementations, the scissor cross members 19, 20 (and 45, 46) may each be comprised of a plurality of members connected at scissor joints, which provide pivot points to the members that allow the members to pivot relative to each other as part of a scissoring movement. If the members are free to move about the scissor joints, the scissor cross members 19, 20 (and 45, 46) can be contracted such that a vertical height of the scissor cross members 19, 20 (and 45, 46) increases and a horizontal width of the scissor cross members decreases (see FIGS. 1E, 1F, 3E, 3F, 4E, 4F), and can be expanded such that the vertical height of the scissor cross members 19, 20 (and 45, 46) decreases and the horizontal width of the scissor cross members increases (see FIGS. 1A, 1B, 3A, 3B, 4A, 4B). If the members are not free to move about the scissor joints, then the scissor cross members 19, 20 (and 45, 46) would not be able to be contracted or expanded and the frame would be secured in a particular configuration.

In various embodiments, ground poles may be connectable via scissor cross members, and in the shown embodiments, at each terminal end of each scissor cross member, an upper member is hingedly attached to an adjacent ground pole and does not slide vertically along the adjacent ground pole, and a lower member is hingedly attached to a sleeve which, in turn, is slidingly attached to the adjacent ground pole. The hinged connection between the lower member and the sleeve allows an angle between the lower member and the sleeve to change with scissor movements of the scissor cross member, and the sliding connection between the sleeve and the ground pole allows for defined movements. The sleeve slides along the ground pole during adjustments of the scissor cross member and may be securable at an upper position of the ground pole (e.g., by looping a hinged loop over a securement member) and may be securable at a lower position of the ground pole (e.g., by force of gravity) to secure the frame in the expanded and retracted configurations, respectively.

In the shown embodiment of FIGS. 1A-1F, 3A-3F, and 4A-4F, the first and fourth ground poles (8, 11 of FIGS. 1A-1F; see corresponding ground poles of FIGS. 3A-3F and 4A-4F) and the second and third ground poles (9, 10 of FIGS. 1A-1F; see corresponding ground poles of FIGS. 3A-3F and 4A-4F and see also additional ground poles of FIGS. 3A-3F) may be connectable via the scissor cross members 19, 20 (see also 45, 46 of FIGS. 3A-3F), such that sleeves 21, 22, 23, 24 (see also 51, 52 of FIGS. 3A-3F) of the scissor cross members slide along the first 8, second 9, third 10, and fourth 11 ground poles (see also additional ground poles of FIGS. 3A-3F) during adjustments of the scissor cross members 19, 20 (and 45, 46), may be securable at upper positions of the ground poles to secure the frame in the expanded configuration (see FIGS. 1A, 1B, 3A, 3B, 4A, and 4B), and may be securable at lower positions of the ground poles to secure the frame in the contracted configuration (see FIGS. 1E, 1F, 3E, 3F, 4E, and 4F).

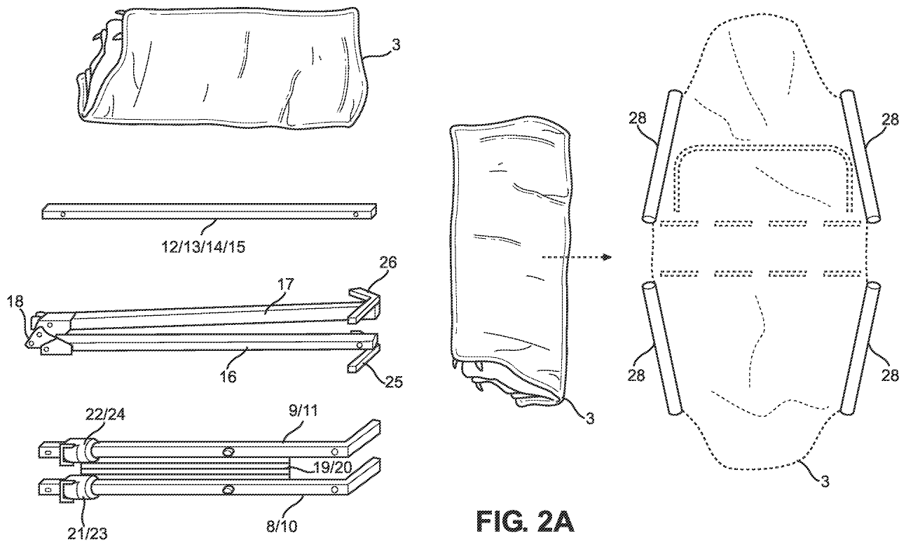

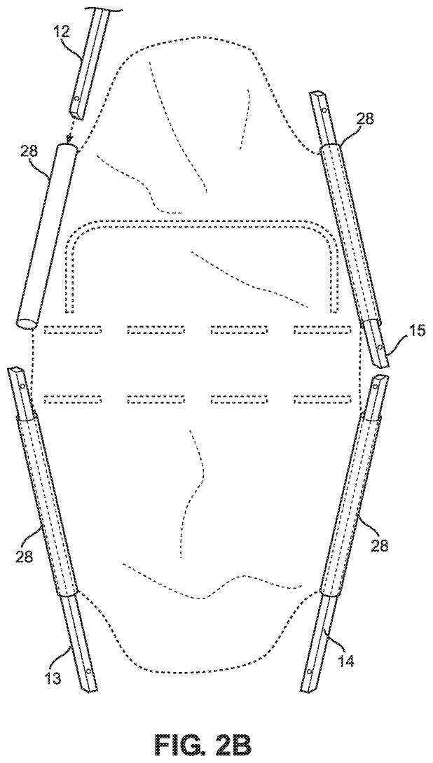

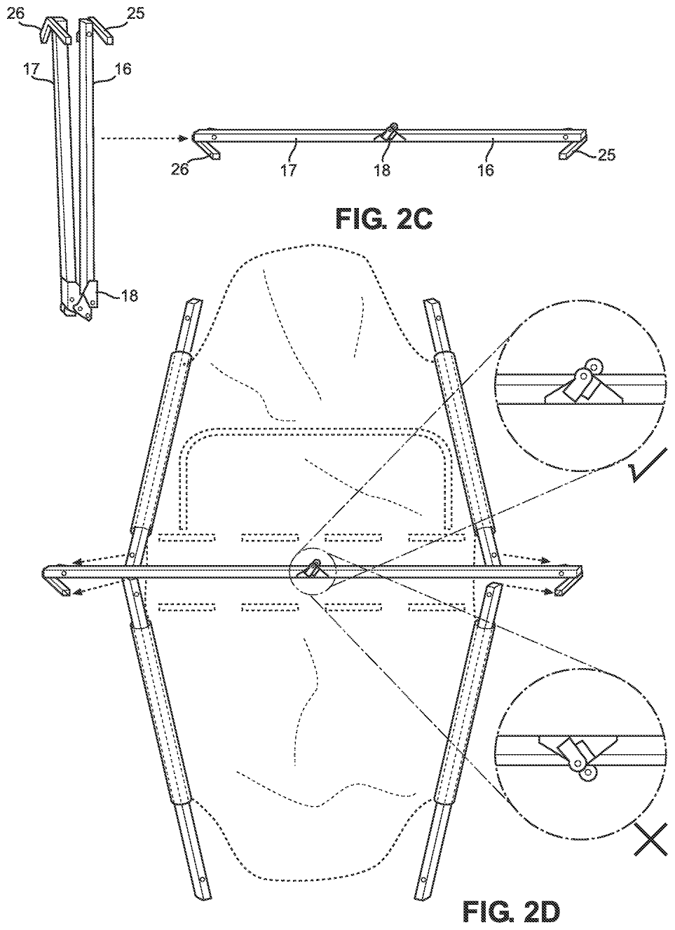

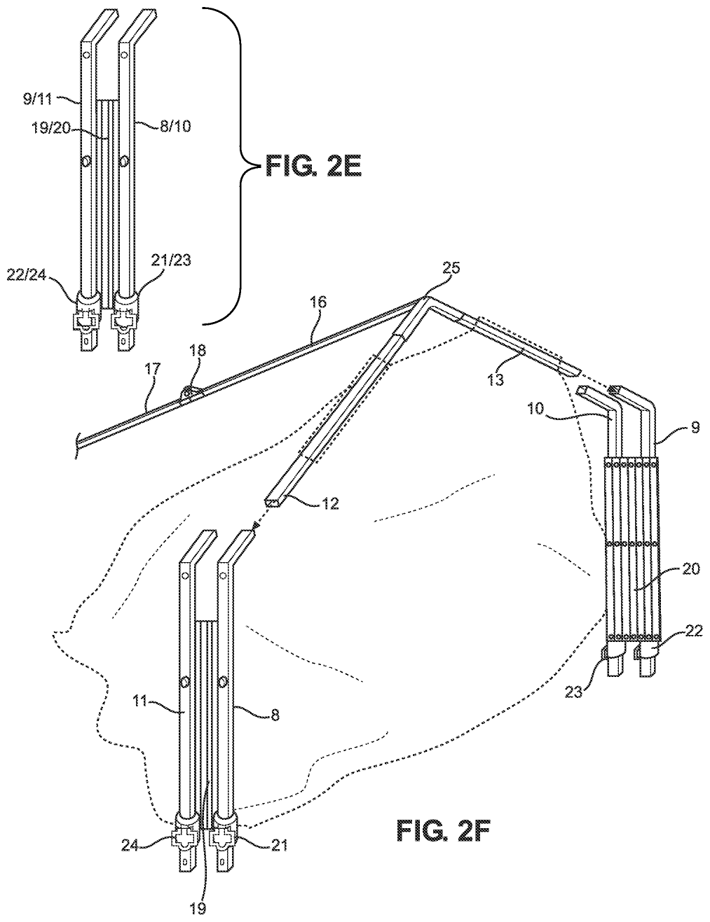

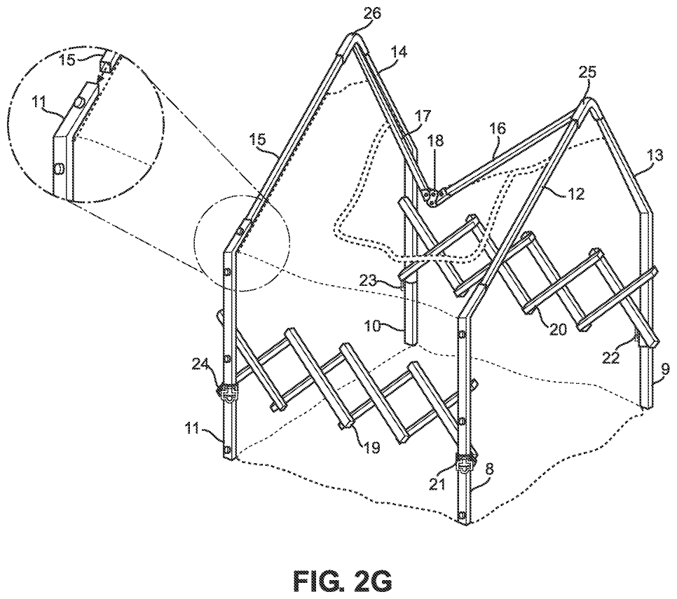

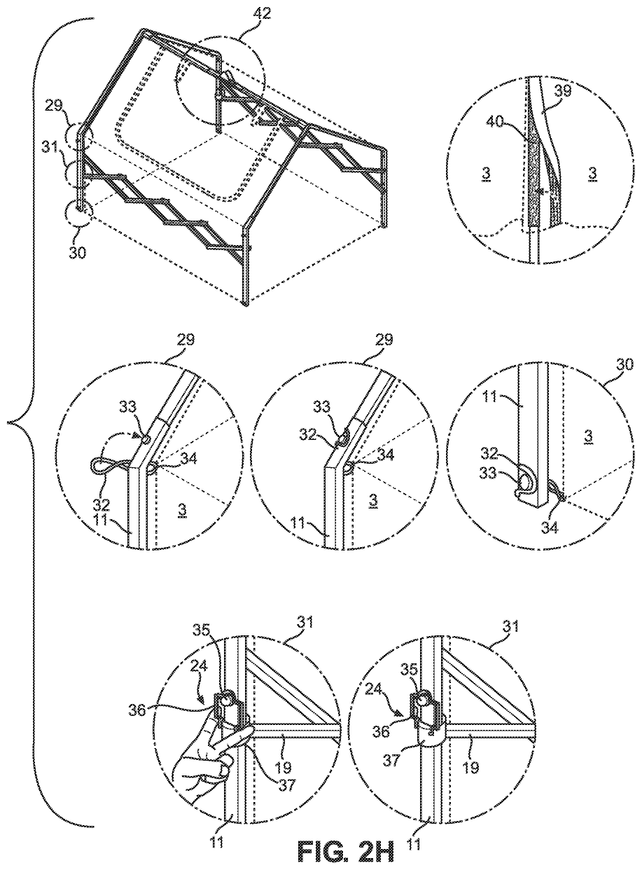

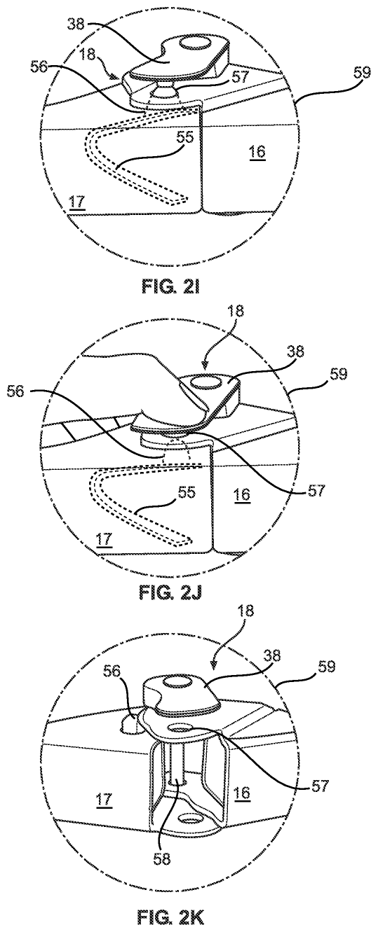

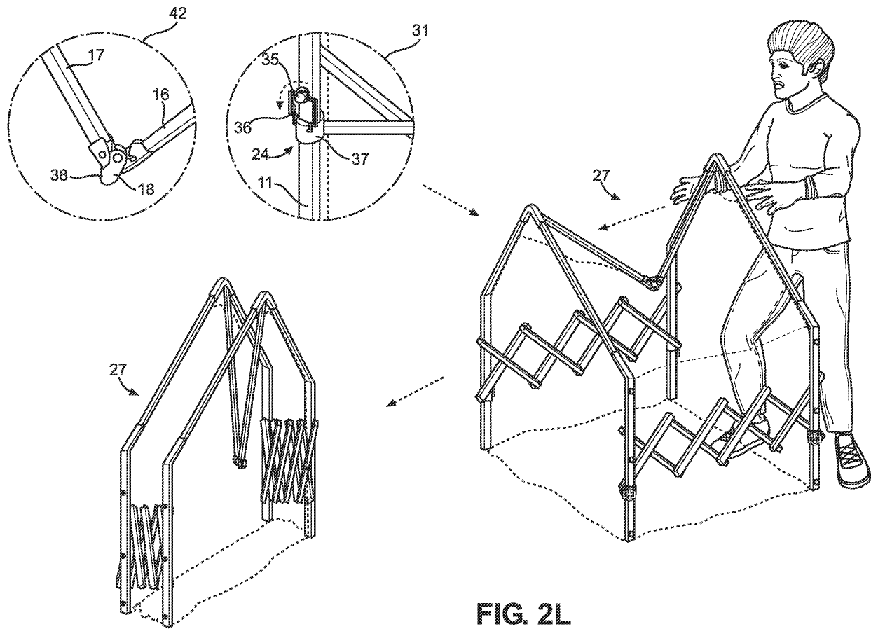

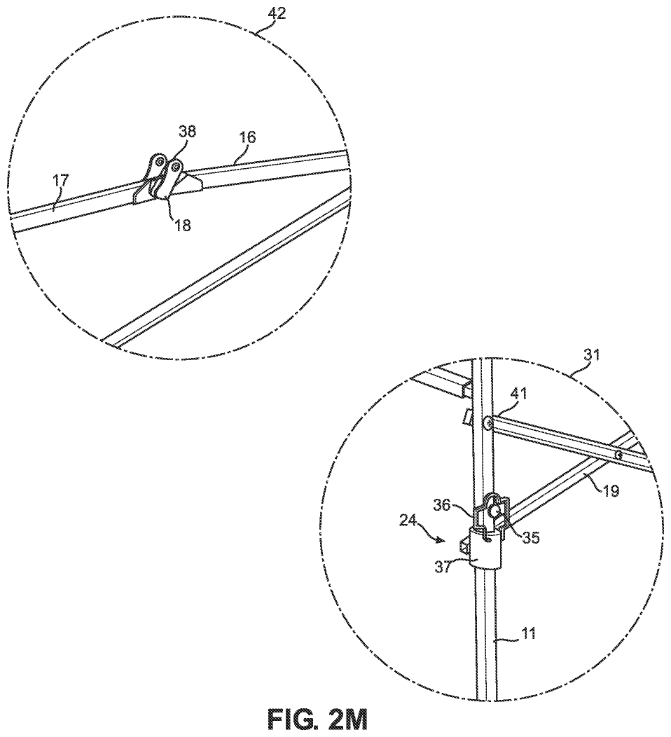

In the expanded configuration the sleeves 21, 22, 23, 24 (and 51, 52) may be relatively distal to lower ends of the ground poles and the ground thereunder, and in the contracted configuration the sleeves 21, 22, 23, 24 (and 51, 52) may be relatively proximal to lower ends of the ground poles and the ground thereunder (see, for example, sleeve 24 of inset 31 of FIG. 2H). In both the expanded configuration and the contracted configuration, as well as an intermediate configuration (see FIGS. 1C, 1D, 3C, 3D, 4C, and 4D), hinged connections of the upper members of the ends of the scissor members (see, for example, upper member 41 of scissor cross member 19 of inset 31 of FIG. 2M) may be consistently positioned relative to lower ends of the ground poles and the ground thereunder. Because the lower members of the ends of the scissor cross members may be hingedly connected to the sleeves, vertical movements of the sleeves along the ground poles correlate with hinged movements of these lower members relative to the sleeves.

In various situations, the device may be subjected to wind and other forces which may cause unwanted or untimely movements, transitions, or reconfigurations of the frame. Accordingly, in various embodiments, any of various securement structures, such as sleeves 21, 22, 23, 24 (and 51, 52) that may be rigidly attached to lower members of the scissor cross members 19, 20 (and 45, 46) and slidingly attached to ground poles, may be used to define acceptable ranges of movement that may occur during reconfiguration of the frame. The securement structures may be locked to secure the frame in place to prevent unwanted or untimely movements of the frame and may be unlocked to release the frame for a reconfiguration of the frame.

In the shown embodiment, the sleeves 21, 22, 23, 24 (and 51, 52) slidingly envelop or attach to the ground poles and may be configured to slide along the ground poles as along a track, a groove, or another regular structure suitable for a sliding movement or a rolling movement and may be secured to upper positions of the ground poles to hold the frame in place. For example, as shown at insets 31 of FIGS. 2H and 2M, sleeve 24 may be secured to the upper position of ground pole 11 by hooking a hinged loop 36, which may be hingedly attached to a body 37 of the sleeve 24, over a securement member 35 which extends outward from the ground pole 11. This arrangement prevents the sleeve 24 from sliding downward along the ground pole 11, which keeps the frame and the device in an upright stance and in an expanded configuration. Since the upper member 41 of the end of the scissor member 19 is unable to slide vertically along the ground pole 11, securing the sleeve 24 to the ground pole 11 in this manner secures the scissor cross member 19 in a stationary position relative to the ground pole 11 and prevents unwanted movements and reconfigurations of the frame. While these structures are explicitly shown for sleeve 24, it is intended that these or equivalent or similar structures are or may be implemented for each of the other sleeves and are shown for sleeve 24 to facilitate this disclosure.

In embodiments, the first ground pole 8 may be connectable to the second ground pole 9 via a third cross member (4 and 5 of FIGS. 1A, 1C, 1E, 3A, 3C, 3E, 4A, 4C, and 4E), and the third ground pole 10 may be connectable to the fourth ground pole 11 via a fourth cross member (6 and 7 of FIGS. 1A, 1C, 1E, 3A, 3C, 3E, 4A, 4C, and 4E; see also additional cross member 43 and 44 of FIGS. 3A, 3C, and 3E). The third and fourth (and additional) cross members may be comprised of a first member (4, 6, and 43) and a second member (5, 7, and 44) which may be affixed to each other such that the cross member as a whole has a constant length or, alternatively, may be connected to each other such that the cross member as a whole has a variable length, as may be achieved with a telescopic arrangement between the first and second members. In a telescopic arrangement, the first member may be slidingly received by, or slidingly engaged with, the second member, or vice versa, and the first and second members may be secured together (e.g., with a fastener to secure the first and second members together, with a locking pin insertable through apertures of the first and second members to secure the first and second members together, etc.) to define a length of the cross member as a whole and a resultant width of the coverage able to be provided by the device in that configuration.

In certain implementations, the third and fourth (and additional) cross members (e.g., 4 and 5, 6 and 7, 43 and 44) may be attached to upper portions of the ground poles, adjacent to and below upper chords (12 and 13, 14 and 15 of FIGS. 1A-1F; see corresponding upper chords of FIGS. 3A-3F and 4A-4F) of the frame, rather than being attached to lower portions of the ground poles. In such an arrangement, the third and fourth (and additional) cross members may be referred to as lower chords of the frame of the device. The lower chords act as a tension tie between the ground poles and prevent outward thrust of the frame, as may occur during high winds or other external forces applied against the cover 3, which may catch the wind and attempt to move the device away from an area of the ground. The lower chords (e.g., 4 and 5, 6 and 7, 43 and 44) may therefore provide improved stability to the frame. However, in various implementations of the device, the lower chords may not necessarily be needed for the frame to maintain stability and may be omitted from the frame or may be included with the frame and installed by a user only if needed, for example, if the user installs the device in an area that regularly experiences high winds. In addition, while not necessarily needed for many installations of the device, other components may included with the frame to secure the device to the ground if needed, including but not limited to stakes, weights, ropes, and tie-downs, for example.

In various implementations, upper portions of the first and second ground poles 8, 9 may be connectable via a first upper chord 12, 13 that includes a first apex 25 and upper portions of the third and fourth ground poles 10, 11 may be connectable via a second upper chord 14, 15 that includes a second apex 26. The first apex 25 may be connectable to the second apex 26 via an adjustable ridge member (16, 17, 18). In the shown embodiment the first apex 25 connects a first limb 12 of the first upper chord to a second limb 13 of the first upper chord, and the second apex 26 connects a first limb 14 of the second upper chord to a second limb 15 of the second upper chord. The limbs (12, 13, 14, 15) provide support to elevate and hold the adjustable ridge member (16, 17, 18) in place, and transfer the weight of the adjustable ridge member (16, 17, 18) and the cover 3 downward through the ground poles and toward the ground to improve stability of the device when installed and in the expanded configuration.

In various embodiments, a hinge joint 18 flexibly connects a first limb 16 of the adjustable ridge member to a second limb 17 of the adjustable ridge member, and may be lockable to secure the first and second limbs (16, 17) of the adjustable ridge member in a parallel and colinear arrangement (e.g., an approximately parallel and colinear arrangement) (see, for example, FIGS. 1A and 1B; expanded configuration), and may be unlockable to release the first and second limbs (16, 17) of the adjustable ridge member from the approximately parallel and colinear arrangement (see, for example, FIGS. 1C and 1D). The first limb 16 may be hingedly attached to the first apex 25 and the second limb may be hingedly attached to the second apex 26. As the frame is transitioned from the expanded configuration (FIGS. 1A and 1B) to the intermediate configuration (FIGS. 1C and 1D), the hinge joint 18 folds downward and the first and second limbs (16, 17) rotate downward about hinged connections with the apexes (25, 26) as the frame collapses, which may be facilitated by force of gravity. The apexes (25, 26) may hingedly engage the limbs (16, 17) at inner portions of the apexes (25, 26) to allow the limbs (16, 17) to rotate in this manner, and in embodiments, one or more of the apexes (25, 26) may be configured to hingedly engage additional limbs at outer portions of the apexes (25, 26) to allow the additional limbs to rotate in this manner as well.

Accordingly, in embodiments, additional ground poles, additional upper chords, and, in certain implementations, additional adjustable cross members, may be utilized with a particular design of the frame, as may be needed for larger frames (see, for example, FIGS. 3A-3F). The inclusion of additional components such as these may involve changes in structure or function of some of these components or may involve a utilization of a structure or feature that may not be utilized for smaller frames (see, for example, FIGS. 1A-1F and 4A-4F). For example, a larger frame (see FIGS. 3A-3F) may include an intermediate apex 50 positioned at an upper portion of an intermediate upper chord, which rests between the first apex 25 and the second apex 26. As the larger frame is transitioned from the expanded configuration (FIGS. 3A and 3B) to the intermediate configuration (FIGS. 3C and 3D), hinge joints 18, 49 of adjustable ridge members fold downward and the limbs of the adjustable ridge members rotate downward about hinged connections with the apexes (25, 26, 50) as the frame collapses, which may be facilitated by force of gravity. The apexes (25, 26, 50) may hingedly engage the limbs of the adjustable ridge members at inner portions of the apexes 25, 26, and at both portions of the intermediate apex 50, to allow the limbs to rotate in this manner. In embodiments the first and second apexes 25, 26 may be the same structure as the intermediate apex 50, with a difference being that the inner portions of the first and second apexes 25, 26 are utilized while the outer portions of the first and second apexes 25, 26 are not utilized, and both portions of the intermediate apex 50 are utilized. However, in other embodiments, the first and second apexes 25, 26 may be different structures or structurally distinct from the intermediate apex 50; for example, the intermediate apex 50 may be configured for two hinged connections while the first and second apexes 25, 26 may be configured for one hinged connection.

In various embodiments, a hinge joint 18 flexibly connects a first limb 16 of the adjustable ridge member to a second limb 17 of the adjustable ridge member, and may be lockable to secure the first and second limbs 16, 17 of the adjustable ridge member in an approximately parallel and colinear arrangement (e.g., FIGS. 1A, 1B, 3A, 3B, 4A, and 4B), and unlockable to release the first and second limbs 16, 17 of the adjustable ridge member from the approximately parallel and colinear arrangement (e.g., FIGS. 1C, 1D, 3C, 3D, 4C, and 4D) (see also additional adjustable ridge members and additional hinge joint 49 of FIGS. 3A-3D). While the hinge joints 18, 49 may be comprised of any suitable lockable joint for securing the limbs in place, in the shown embodiments, the hinge joints 18, 49 include a push button locking system (see, e.g., inset 59 of FIGS. 21, 2J, and 2K) that includes a hinge 58 that hingedly connects the limbs 16, 17 to the hinge joint 18. As the limbs 16, 17 are moved upward, they pivot about the hinge of the hinge joints 18, 49 and may snap into place and be secured in the approximately parallel and colinear arrangement by a push button locking system (55, 56, 57), as shown. If the hinge joint needs to be released, for example to reconfigure or disassemble the frame, a user may engage a release mechanism 38 of the locking system which depresses an exposed portion of a ball 56 of a spring member 55 through an aperture 57 of limb 16. The spring member 55 is shown in broken lines and may be positioned within hollow limb 17, as shown. The spring member 55 may be a metal or metallic member that exhibits a bias, such that there may be a resistance felt by a user when depressing the ball 56 of the spring member 55 with the release mechanism 38. The bias may be helpful to prevent the spring member 55 from moving and causing the hinge joint 18 from becoming unlocked when not intended. Depression of the spring member 55 in turn unlocks the hinge joint 18 and allows the limbs 16, 17 to move freely (e.g., within a range defined by structures of the components) relative to the hinge joint 18.

In various embodiments, the covers (e.g., 3) of the ground cover devices may be attached to the frames such that the frame is entirely exterior to the cover when these components are connected, such that an interior volume of the cover does not contain any portion of the frame. In this configuration, the cover drapes the ground to create and maintain a seal with the ground (including uneven and irregular areas of the ground). The seal may help retain moisture within the interior of the cover, which encourages plant growth. By having the frame outside the cover, the frame may be protected from rusting and deterioration that may occur due to exposure to humidity within the interior of the cover, and in this manner the lifespan of the frame may be prolonged. This configuration may also reduce stress and strain on the cover because the cover is not stretched or pulled around the frame which may cause tearing and damage to the cover, and in this manner the lifespan of the cover may be prolonged. However, in other configurations, the frame may be interior to the cover. In such configurations, the frame may be protected from adverse weather and UV light exposure due to sunlight.

In various embodiments, the cover includes a transparent portion that allows all or part of sunlight to pass therethrough to reach the interior volume of the cover. An appropriate amount of sunlight may facilitate plant growth within the greenhouse device. The transparent portion may be comprised of an optically transparent flexible material, such as an optically transparent plastic, which can fold and flex with the cover as needed. In this manner, the transparent portion may not be susceptible to damage with folding and flexing of the cover.

In embodiments, the ground cover device may be provided as a standalone configuration and may not be modular or may not be able to be combined with additional ground cover device components to create additional or alternative configurations or arrangements of the components. However, in other embodiments, the ground cover device may be provided as a modular ground cover device that is comprised of components that may be assembled into any number of repeatable units to create a variety of sizes and configurations. The decision to implement the ground cover device as a modular or non-modular device may be driven by cost-benefit or design considerations. In addition, in various embodiments, the ground cover device components may include anti-weathering features, such as anti-weathering coatings or materials or anti-UV light coatings or materials, which preserve the components and prevent them from being deteriorated with ordinary use and exposure to the elements. In this manner, the lifespan of the ground cover may be extended, and the consumer may not need to repair or replace the device for a longer period of time.

b. Assembly and Use

Referring now to FIGS. 2A and 2B, there are shown a perspective view of several components of a ground cover device, in an unassembled state (FIG. 2A), and a perspective view of an assembly of a cover (FIG. 2B). A ground cover device may be provided as a collection of components (e.g., a kit) that includes a cover 3, upper chords 12, 13, 14, and 15, an adjustable ridge member (16, 17, 18) that is hingedly connected with apexes 25, 26, and scissor members 19, 20 that are connected with ground poles 8 and 11, and 9 and 10. The cover 3 may be unfolded to reveal a plurality of upper chord sleeves 28, as shown at FIG. 2A, prior to assembly. The cover 3 may include vents of any of various sizes and shapes that may be opened to ventilate the interior of the greenhouse device as needed and closed as not needed. The vents may be shaped as elongated apertures and may be operable with a zipper, a hook and loop attachment, a button attachment, or another type of attachment suitable for opening and closing the vents. To assemble the cover 3, the upper chords 12, 13, 14, and 15 may be inserted through the upper chord sleeves 28, as shown at FIG. 2B.

After the cover is assembled with the upper chords inserted, the cover may be laid down on a surface, such as an area of flat ground, as shown at FIG. 2D, and the adjustable ridge member unfolded, as shown at FIG. 2C, such that the first and second limbs (16, 17) of the adjustable ridge member form the approximately parallel and colinear arrangement. The unfolded adjustable ridge member may be laid upon the cover, as shown at FIG. 2D, with the hinge joint 18 oriented such that it will fold downward, toward the cover, when released from the approximately parallel and colinear arrangement. The upper chords may be connected to the apexes by inserting lower portions of the apex into upper ends of the upper chords, as indicated by broken arrows at FIG. 2D. The scissor members 19, 20 may be attached to the upper chords, as shown at FIGS. 2E and 2F, by inserting upper portions of the ground poles 8, 9 into lower ends of the upper chords 12, 13; this operation may be repeated for the other ground poles 10, 11 to be attached to the other upper chords 14, 15, as shown at FIG. 2G.

Various steps may be involved with attaching the cover to the frame for a particular embodiment, as shown at FIG. 2H at insets 29 and 30. The cover 3 may include a plurality of elastic loops 32 attached at attachment points 34 of the exterior of the cover 3. The loops 32 may be stretched and looped around securement members 33 that extend from the frame at certain locations on the frame, such as an angled portion of the ground pole 11 (inset 29) and a lower portion of the ground pole 11 (inset 30). The elastic loops 32 may be bungee cords or rubber cords and may hold the cover 3 firmly but not overly taut, such that the cover 3 may be able to form and maintain an effective seal the with the ground. As shown at FIG. 2H at insets 31, the sleeve 24 may be secured to the upper position of ground pole 11 by hooking a hinged loop 36, which may be hingedly attached to a body 37 of the sleeve 24, over a securement member 35 which extends outward from the ground pole 11. This arrangement prevents the sleeve 24 from sliding downward along the ground pole 11, which keeps the frame and the device in an upright stance and in an expanded configuration.

Once the ground cover device is assembled and in the expanded configuration, it may be transitioned to an intermediate configuration and a contracted configuration as shown at FIG. 2L, including at insets 42 and 31 of FIG. 2L (see also insets 42 and 31 of FIG. 2H). As shown at FIG. 2L, a user may engage a release mechanism 38 of the locking system which unlocks the hinge joint 18 and allows the limbs to move freely relative to the hinge joint 18 (see also FIGS. 21, 2J, and 2K). The user may also unlock the sleeve 24 from the upper position of the ground pole 11 by unhooking the hinged loop 36, which may be hingedly attached to the body 37 of the sleeve 24, from the securement member 35 which extends outward from the ground pole 11 (see also insets 31 of FIG. 2H). This manipulation allows the sleeve 24 to slide downward along the ground pole 11, which allows the frame and the device 27 to transition out of the upright stance and the expanded configuration and toward an intermediate configuration (FIG. 2L, right). From there, the user can manually compress the frame such that the device 27 is transitioned toward the contracted configuration (FIG. 2L, left). In the contracted configuration, the ground cover device may be more easily stored when not in use, for example, in a garage, next to a building or home, in a vehicle, in a shed, etc.

### III. Ground Cover Kits

In various aspects, this disclosure provides kits comprised of a ground cover device (e.g., a greenhouse device) of the disclosure. An exemplary kit may include a cover 3, upper chords 12, 13, 14, and 15 that are securable to apexes 25, 26, an adjustable ridge member (16, 17, 18) that is hingedly connectible to apexes 25, 26, and scissor members 19, 20 that are securable to ground poles 8 and 11, and 9 and 10. Other kits may include multiple instances or embodiments of these or other components or accessories. In various embodiments, a kit is provided that includes components of the ground cover device as well as instructional materials that may be used to help a user assemble the device, such as printed materials, audio materials, video materials, or a different type of instructional material. The instructional materials may provide a sequence of steps that may be performed to assemble the device, for example, a method of assembly.

### IV. Ground Cover Methods

In yet another aspect, this disclosure provides various methods for assembling ground kit devices. For example, a method may comprise providing a cover, a plurality of upper chords that are securable to apexes, an adjustable ridge member that is hingedly connectible to apexes, and adjustable cross members that are securable to ground poles; securing the upper chords to the cover and the apexes; securing the adjustable ridge member to the apexes; and securing the ground poles to the upper chords. The method may further comprise connecting additional cross members to assemble the frame and the device. The method may further comprise expanding the device to an expanded configuration and securing the device in the expanded configuration and placing the device over a portion of a ground or a garden. The method may further comprise contracting the device to a contracted configuration and storing or transporting the device.

The foregoing descriptions of specific implementations have been presented for purposes of illustration and description. They are not intended to be exhaustive or to limit the invention to the precise forms disclosed, and modifications and variations are possible in view of the above teaching. The exemplary implementations were chosen and described to best explain the principles of the invention and its practical application, to thereby enable others skilled in the art to best utilize the invention and its implementations with modifications as suited to the use contemplated.

It is therefore submitted that the invention has been shown and described in the most practical and exemplary implementations. It should be recognized that departures may be made which fall within the scope of the invention. With respect to the description provided herein, it is submitted that the optimal features of the invention include variations in size, materials, shape, form, function, manner of operation, assembly, and use. All structures, functions, and relationships equivalent or essentially equivalent to those disclosed are intended to be encompassed by the invention.

I claim:

1. A ground cover device, comprising a frame and a cover that is removably attachable to the frame; wherein the frame comprises:
a plurality of ground poles that are connectable via a plurality of adjustable cross members; wherein distances between ground poles are adjustable via adjustments of cross members;
wherein cross members are adjustable to transition the frame from a contracted configuration to an expanded configuration and from the expanded configuration to the contracted configuration.

2. The ground cover device of claim 1, wherein the expanded configuration of the frame configures the ground cover device to cover a portion of a garden.

3. The ground cover device of claim 1, wherein the contracted configuration of the frame configures the ground cover device for storage or transport of the ground cover device.

4. The ground cover device of claim 1, wherein the ground poles includes a first ground pole, a second ground pole, a third ground pole, and a fourth ground pole;
wherein the first ground pole is connectable to the fourth ground pole via a first adjustable cross member; and
wherein the second ground pole is connectable to the third ground pole via a second adjustable cross member.

5. The ground cover device of claim 4, wherein the first and second adjustable cross members are scissor cross members.

6. The ground cover device of claim 5, wherein the first and fourth ground poles and the second and third ground poles are connectable via the scissor cross members, such that sleeves of the scissor cross members:
slide along the first, second, third, and fourth ground poles during adjustments of the scissor cross members;
are securable at upper positions of the first, second, third, and fourth ground poles to secure the frame in the expanded configuration; and
are securable at lower positions of the first, second, third, and fourth ground poles to secure the frame in the contracted configuration.

7. The ground cover device of claim 4, wherein the first ground pole is connectable to the second ground pole via a third cross member, and the third ground pole is connectable to the fourth ground pole via a fourth cross member.

8. The ground cover device of claim 7, wherein the third and fourth cross members are lower chords of the frame.

9. The ground cover device of claim 4, wherein upper portions of the first and second ground poles are connectable via a first upper chord that includes a first apex and upper portions of the third and fourth ground poles are connectable via a second upper chord that includes a second apex;
wherein the first apex is connectable to the second apex via an adjustable ridge member.

10. The ground cover device of claim 9, wherein the first apex connects a first limb of the first upper chord to a second limb of the first upper chord, and the second apex connects a first limb of the second upper chord to a second limb of the second upper chord.

11. The ground cover device of claim 9, wherein a hinge joint flexibly connects a first limb of the adjustable ridge member to a second limb of the adjustable ridge member, is lockable to secure the first and second limbs of the adjustable ridge member in an approximately parallel and colinear arrangement, and is unlockable to release the first and second limbs of the adjustable ridge member from the approximately parallel and colinear arrangement.

12. The ground cover device of claim 4, wherein the cover is removably attached to the frame an interior volume of the cover does not contain any portion of the frame.

13. The ground cover device of claim 11, wherein the cover is removably attached to the frame, a lower perimeter edge of the cover reliably contacts a ground thereunder to seal the interior volume of the cover from an exterior of the cover.

14. The ground cover device of claim 11, wherein the cover includes a transparent portion that allows sunlight to pass therethrough to reach the interior volume of the cover.

15. A greenhouse device comprising a frame, wherein the frame comprises:
a first upper chord that includes a first apex and a second upper chord that includes a second apex, wherein the first apex is connectable to the second apex via an adjustable ridge member;
a plurality of ground poles that includes a first ground pole, a second ground pole, a third ground pole, and a fourth ground pole;
wherein upper portions of the first and second ground poles are connectable via the first upper chord and upper portions of the third and fourth ground poles are connectable via the second upper chord;
wherein the first ground pole is connectable to the fourth ground pole via a first scissor cross member and the second ground pole is connectable to the third ground pole via a second scissor cross member;
wherein the first scissor cross member, the second scissor cross member, and the adjustable ridge member are adjustable to transition the frame from a contracted configuration to an expanded configuration and from the expanded configuration to the contracted configuration.

16. The greenhouse device of claim 15, wherein the first ground pole is connectable to the second ground pole via a first lower chord, and the third ground pole is connectable to the fourth ground pole via a second lower chord.

17. The greenhouse device of claim 15, wherein sleeves of the first and second scissor cross members:
slide along the first, second, third, and fourth ground poles during adjustments of the scissor cross members;
are securable at upper positions of the first, second, third, and fourth ground poles to secure the frame in the expanded configuration; and
are securable at lower positions of the first, second, third, and fourth ground poles to secure the frame in the contracted configuration.

18. The greenhouse device of claim 15, wherein the first apex connects a first limb of the first upper chord to a second limb of the first upper chord, and the second apex connects a first limb of the second upper chord to a second limb of the second upper chord;
wherein a hinge joint:
flexibly connects a first limb of the adjustable ridge member to a second limb of the adjustable ridge member;
is lockable to secure the first and second limbs of the adjustable ridge member in an approximately parallel and colinear arrangement; and
is unlockable to release the first and second limbs of the adjustable ridge member from the approximately parallel and colinear arrangement.

19. A greenhouse device, comprising a frame and a cover that is removably attachable to the frame;
wherein the frame comprises: a plurality of ground poles that are connectable via a plurality of adjustable cross members, wherein distances between ground poles are adjustable via adjustments of cross members;
wherein the cover comprises: a plurality of fasteners affixed to an exterior surface thereof, wherein fasteners reversibly connect the cover to the frame such that an interior volume of the cover does not contain any portion of the frame and a lower perimeter edge of the cover reliably contacts a ground thereunder to seal the interior volume of the cover from an exterior of the cover;
wherein cross members are adjustable to transition the frame from a contracted configuration to an expanded configuration and from the expanded configuration to the contracted configuration.

20. The greenhouse device of claim 19, wherein the expanded configuration of the frame configures the greenhouse device to cover a portion of a garden, and wherein the contracted configuration of the frame configures the greenhouse device for storage or transport of the greenhouse device.
